(19) United States
(12) Patent Application Publication
(10) Pub. No.: US 2005/0148225 A1
(43) Pub. Date: Jul. 7, 2005

(54) Telecommunications patch jack having wishbone actuator with bifurcated contact

(76) Inventors: Wayne A. Zahlit, Thousand Oaks, CA (US); Jeffrey C. Murphy, Winnetka, CA (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/752,035

(22) Filed: Jan. 7, 2004

(51) Int. Cl. H01R 29/00

(52) U.S. Cl. 439/188

(57) ABSTRACT

An electrical contact pair includes a substantially cylindrical first conductor and an elongated second conductor. The second conductor has an end normally biased against the first conductor based on a spring-type resiliency of the second conductor. The second conductor end is bifurcated via a substantially V-shaped notch for engaging the first conductor. The contact pair can be used, for example, in a variety of telecommunications, video and RF (radio frequency) applications including a communications jack, a patch jack, and a digital cross-connect assembly.

### BACKGROUND OF THE INVENTION

1. Field of the Invention

The present invention is related to a telecommunications patch jack and a bifurcated contact for same.

2. Background Art

In the telecommunications industry (including, for example, telephone and television broadcast), a patch jack assembly is used to connect two signal lines and to facilitate rerouting of the lines, if necessary. For example, a typical patch jack assembly includes a housing having a pair of parallel, substantially cylindrical, coaxial connections running therethrough. Each coaxial connection includes a center conductor and an outer conductor. The outer conductor is typically formed as part of the housing. Each connection runs from a rear port at a rear of the housing to a front port at a front of the housing. The rear ports are typically configured as BNC jacks, while the front ports are typically configured as WECo (Western Electric Company) or mini WECo jacks.

The rear BNC jacks are configured to receive the lines for which connection is desired. A spring arrangement within the housing provides a normally closed connection between the center conductor of each coaxial connection. Thus, the lines connected to the BNC jacks at the rear of the assembly will be electrically connected by the spring arrangement in the housing.

A typical configuration of the spring arrangement is a wishbone shaped spring having a central portion and two arms. The central portion is fixed to the housing. A distal end of each arm is configured to contact an adjacent central conductor of one of the coaxial connections. The distal ends are held against the central conductor by the restorative force of the spring. This configuration provides a conductive path between two central conductors to form the normally closed connection.

Each arm has a non-conductive actuator attached to it. A plug inserted into one of the front ports of the housing will engage the actuator and push the spring arm away from the central conductor (against the restorative force of the spring arm) causing the electrical connection to be broken. In a terminated variant, the spring arm is pushed into contact with a ground post, causing the central conductor of the other connection to be electrically connected to ground through a termination resistor. In a non-terminated variant, the spring arm is pushed away from the central conductor, but remains non-terminated or open-circuited.

Reliability of the connections made by the patch jack assembly is important. However, a shortcoming of conventional patch jack assemblies is found in the spring assembly. As seen in FIG. 1, the spring arms 100 of the spring assembly are typically thin and flat with a rectangular cross-section, while the central conductors 102 are typically cylindrical in shape. Because of these shapes, the resulting contact point 104 is often a single point or a narrow line. Dirt, dust, or other debris entering the housing can get stuck between spring 100 arm and conductor 102, and make an intermittent or even cold (i.e., non-conducting) connection at point 104.

Therefore, what is needed is a jack that produces an electrical connection that is less susceptible to failure.

### BRIEF SUMMARY OF THE INVENTION

An embodiment of the present invention provides an electrical contact pair including a substantially cylindrical first conductor and an elongated second conductor. The second conductor has a first end held in a fixed position relative to the first conductor and a second end movable relative to the first conductor. The second end is normally biased against the first conductor based on a spring-type resiliency of the second conductor. The second end is bifurcated.

Another embodiment of the present invention provides a feed-through jack including a body having a first end and a second end, a substantially cylindrical conductor extending longitudinally through the body between a first jack at the first end and a second jack at the second end, and an actuator having a bifurcated contact configured to contact the substantially cylindrical conductor. The bifurcated contact is movable between a first position in electrical communication with the substantially cylindrical conductor and a second position electrically isolated from the substantially cylindrical conductor. A plug inserted into the first jack causes the bifurcated contact to move to the second position.

A still further embodiment of the present invention provides a patch jack including a body, first and second conductors, and a wishbone shaped actuator. The body has a first end and a second end. The first conductor extends longitudinally through the body between a first jack at the first end and a second jack at the second end. The second conductor extends longitudinally through the body between a third jack at the first end and a fourth jack at the second end. The wishbone-shaped actuator has first and second arms. Each arm has a bifurcated contact configured to contact a respective one of the conductors. Each of the arms has a first position in electrical communication with the respective conductor and a second position electrically isolated from the respective conductor. A plug inserted into the first jack causes the first arm to move to the second position. A plug inserted into the third jack causes the second arm to move to the second position.

In one patch jack embodiment, the connector housing is formed from zinc allow no. 3 per ASTM B240 with electroless nickel per AMS 2404C. The actuator and center conductors are made from beryllium copper per ASTM-B194/196/197 and are gold plated per MIL-G-45204. Dielectric insulators isolating the center conductors from the housing are formed from PTFE (polytetrafluoroethylene) per ASTM-D1710.

In a preferred embodiment, the bifurcated contact of the invention comprises a substantially V-shaped notch for engaging the first conductor. Using a bifurcated contact provides for multiple points of contact/engagement with the first conductor, increases Hertzian forces, reduces susceptibility to failure caused by contamination, and yields a more reliable connection.

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a conventional electrical contact pair.

FIG. 2 shows an electrical contact pair according to an embodiment of the present invention.

FIG. 3 shows a spring arrangement according to an embodiment of the present invention.

FIGS. 4 and 5 show cross-sectional and perspective views, respectively, of a patch jack having the spring arrangement in a first position according to an embodiment of the present invention.

FIG. 6 shows the patch jack of FIGS. 4 and 5 having the actuator in a second position.

FIGS. 7, 8, 9, and 10 show various embodiments of the bifurcated contact of the present invention.

The present invention will now be described with reference to the accompanying drawings. In the drawings, like reference numbers generally indicate identical or functionally similar elements. Additionally, the left-most digit(s) of a reference number generally identifies the drawing in which the reference number first appears.

### DETAILED DESCRIPTION OF THE INVENTION

Overview

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

An embodiment of the present invention provides an electrical contact pair including a substantially cylindrical first conductor and an elongated second conductor. The contact pair can be used, for example, in a variety of telecommunications, video, and RF (radio frequency) applications. For example, the contact pair can be used in a communications jack, a patch jack such as the 75 Ohm High Frequency, Dual Coaxial, Normal-Thru Mini-WECo Patch Jack, available from Trompeter Electronics, Inc. of Westlake Village, Calif., under part numbers J314MW (non-terminated) and J314MWT (terminated), or a digital cross-connect assembly of the type used, for example, in telephone central offices.

The second conductor has a first end held in a fixed position relative to the first conductor and a second end movable relative to the first conductor. The second end is normally biased against the first conductor based on a spring-type resiliency of the second conductor. The second end is bifurcated via a substantially V-shaped notch for engaging the first conductor. A portion of the V-shaped notch can be wider than a diameter of the first conductor, so as to rest on either side of the conductor. However, in one embodiment, the V-shaped notch has a widest point that is smaller than the diameter of the first conductor. Using the bifurcated end allows for an increased force or stress (e.g., Hertzian stress or force) between the first and second conductors and an increase in electrical performance and reliability.

Electrical Contact Pair

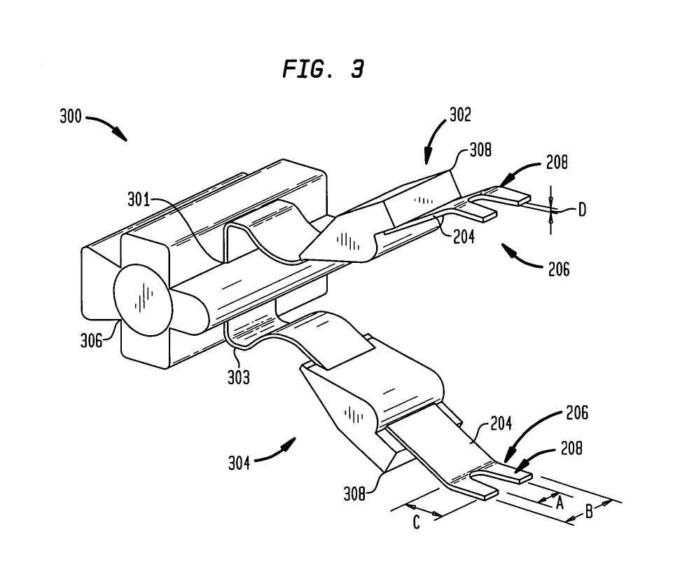

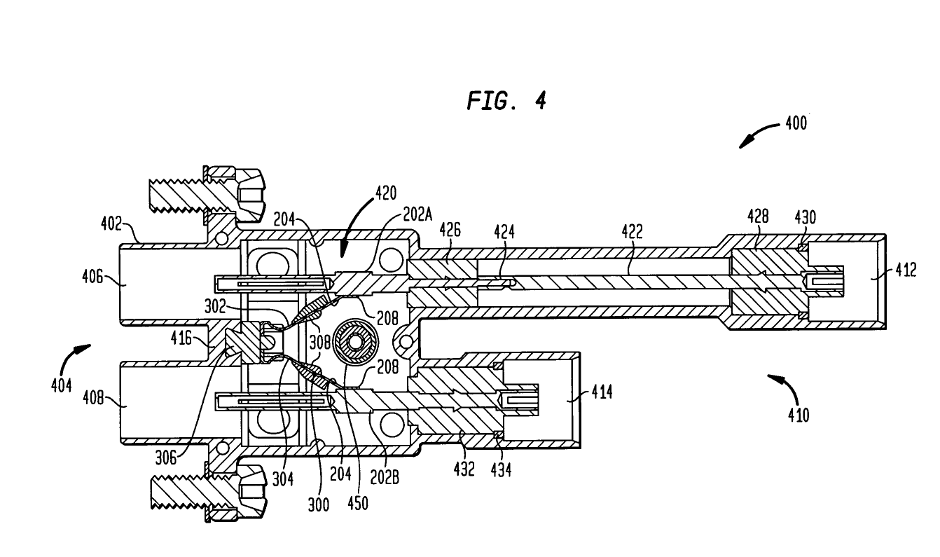

FIG. 2 shows an electrical contact pair 200 according to embodiments of the present invention. Electrical contact pair 200 includes a substantially cylindrical first conductor 202 and an elongated second conductor 204. Elongated second conductor 204 has a first end 301 (FIG. 3) held in a fixed position relative to first conductor 202 and a second end 206 movable relative to first conductor 202. Second end 206 can be normally biased against first conductor 202 based on a spring-type resiliency of second conductor 204. Second end 206 includes a bifurcated contact 208 formed via substantially V-shaped notch 210, for engaging first conductor 202.

It is to be appreciated that first and second conductors 202 and 204 can be made of any material that allows communication of signals through the conductors, such as metal, alloys, or the like. In a preferred embodiment, first conductor 202 and second conductor 204 are made from beryllium copper per ASTM-B194/196/197 and are gold plated per MIL-G-45204.

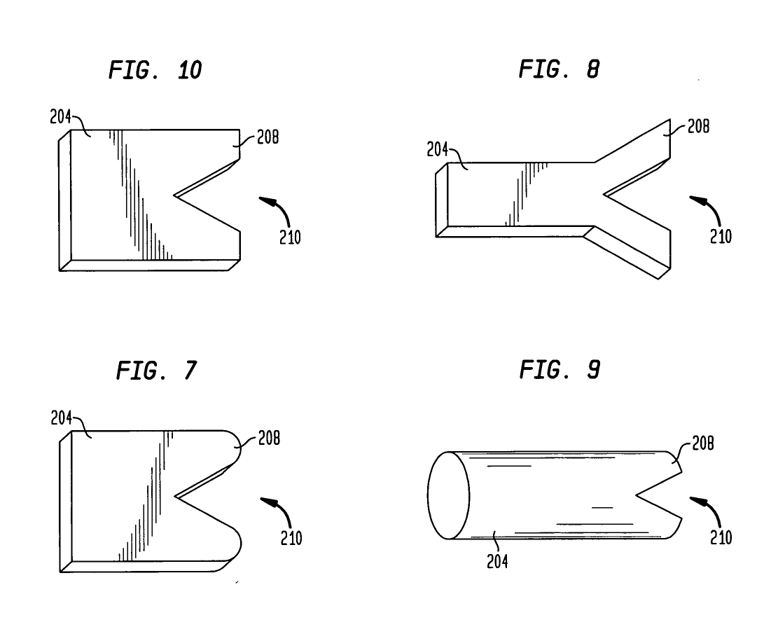

FIGS. 7, 8, 9, and 10 show various example configurations for bifurcated contact 208. It is to be appreciated that a thickness of second conductor 204 and/or bifurcated contact 208 is such that bifurcated contact 208 is biased against conductor 202 by a spring-type resiliency.

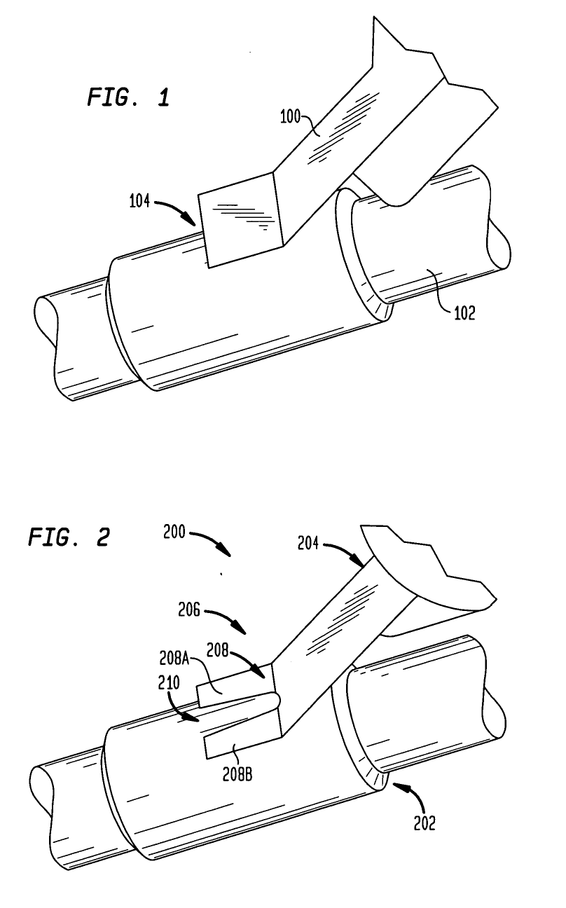

As depicted in FIGS. 1-5, 7, 8 and 10, second conductor 204 can have a substantially rectangular cross-section. As depicted in FIG. 9, second conductor 204 can also have a substantially cylindrical cross-section. Also, bifurcated contact 208 can have substantially squared (FIGS. 7 and 10) or substantially rounded (FIGS. 8 and 9) corners. Further, bifurcated contact 208 can have a Y-shaped end (FIG. 8). It is to be appreciated these various embodiments are merely exemplary and are not exhaustive. Various other cross-sectional shapes and end shapes are contemplated within the scope of the present invention, as would be apparent to a skilled artisan upon reading the description of the invention.

Referring back to FIG. 2, a configuration of V-shaped notch 210 having a short, wide notch as depicted is preferred, because a narrow and deep notch may result in a contact that does not provide the desired force/stress at the points of contact. However, other shapes are contemplated within the scope of the present invention. In some cases, the V-shaped notch 210 can have a portion that is larger than an outer diameter of first conductor 202. In that case, first conductor 202 can rest between bifurcated portions 208A and 208B. This can substantially eliminate any relative movement of bifurcated contact 208 with respect to first conductor 202 during interaction between first conductor 202 and second conductor 204. This can also result in an improved electrical connection between first conductor 202 and second conductor 204 compared to the single point contact, discussed above and shown in FIG. 1.

Bifurcated portions 208A and 208B can be biased towards each other and towards first conductor 202 based on the resilient nature of second conductor 204. The biasing can produce a force or stress between bifurcated contact 208 and first conductor 202 during interaction of first conductor 202 and second conductor 204. Thus, through use of bifurcated contact 208, interaction between first conductor 202 and second conductor 104 can have increased force and/or stress (e.g., Hertzian stress or force) and/or improved electrical performance.

Spring or Actuator Assembly

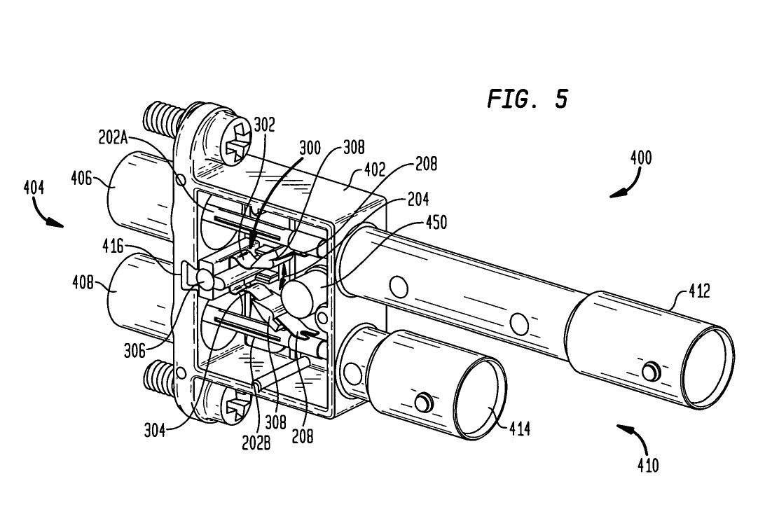

FIG. 3 shows a spring assembly 300 according to an embodiment of the present invention. Spring or actuator assembly 300 is formed in a wishbone shape and includes first and second arms 302 and 304 connected at a central portion 303. A coupling device 306, formed from a non-conductive material, is attached to spring assembly 300 at central portion 303. Coupling device 306 is used to couple spring assembly 300 to a housing of a patch jack or other assembly, as illustrated in FIGS. 4-6 and discussed below.

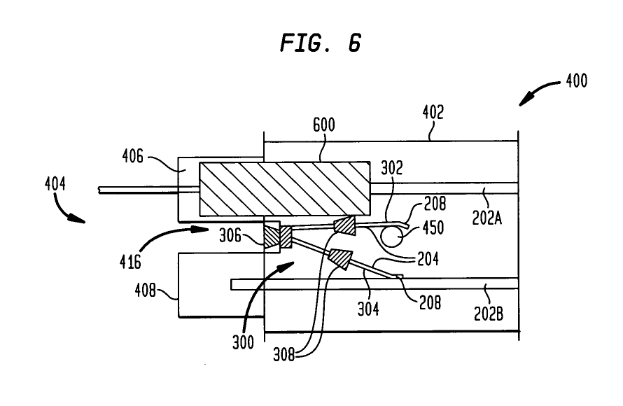

Each arm 302 and 304 of spring assembly 300 includes a second conductor 204 and a non-conductive contact or actuator 308 (e.g., a plastic ramp, or the like). Non-conducting contact or actuator 308 is positioned on arms 302 and 304 to interact with a plug 600 (described below with reference to FIG. 6) when plug 600 is inserted into a port 406 (described below with reference to FIGS. 4 and 6) of patch jack 400 (FIGS. 4-6).

It an exemplary embodiment, second conductor 204 is formed from a thin strip of beryllium copper. In this embodiment, bifurcated contact 208 can have a notch width A of approximately 0.043 inches, a width B of approximately 0.100 inches, a length C of approximately 0.060 inches and a thickness D of approximately 0.006 inches.

Patch Jack

FIGS. 4 and 5 show cross-sectional and perspective views, respectively, of a patch jack 400 according to an embodiment of the present invention. Patch jack 400 can be used, for example, in a telecommunications or video distribution system. Patch jack 400 has a jack body 402 including a first end 404 (e.g., a front end) with first and third jacks (or ports) 406 and 408 and a second end 410 (e.g., a rear end) with second and fourth jacks (or ports) 412 and 414. In various embodiments, jacks 406 and 408 can have WECo or a mini-WECo formats, and jacks 412 and 414 can have BNC or mini-BNC formats. First conductor 202A extends longitudinally through jack body 402 from first jack 406 to second jack 412. First conductor 202B extends longitudinally through jack body 402 from third jack 408 to fourth jack 414. Jack body 402 has formed therein a recess 416 configured to mate with coupling device 306 of spring assembly 300 and secure spring assembly 300 within body 402.

In the embodiment shown, first conductor 202A includes first and second sections 420 and 422. First and second sections 420 and 422 are coupled at point 424 via soldering, crimping, or the like. First section 420 passes through a dielectric material 426 in body 402, and second section 422 passes through a dielectric material 428 in body 402 near jack 412. Dielectric material 428 can be held in place using a retaining ring 430, or the like. Similarly, first conductor 202B passes through a dielectric 432 in body 402 near fourth port 414, which can he held in place using a retaining ring 434, or the like.

It is to be appreciated that, although shown as two different lengths, the conductive paths through body 402 formed by first conductors 202A and 202B can be the same length, as would be apparent to one skilled in the art. These variations and others are contemplated within the scope of the present invention.

FIG. 6 shows a partial plan view of patch jack 400 with a plug 600 inserted into port 406. As depicted, upon insertion into port 406, plug 600 interacts with non-conducting contact or actuator 308 of first arm 302. This causes arm 302, including bifurcated contact 208, to move between a first position, in electrical communication with first conductor 202A, and a second position, electrically isolated from first conductor 202A. In the second position in one embodiment of the invention, bifurcated contact 208 is in electrical communication with a termination pin 450. Typically, termination pin 450 will shunt a signal from contact 208 to ground through an impedance matching, termination resister (not shown). In an alternative embodiment of the invention (not shown), in the second position bifurcated contact 208 is not in electrical communication with termination pin 450, but is left open-circuited. It is to be appreciated that a plug inserted into third port 408 will interact with non-conducting contact 308 of second arm 304 in a similar manner.

It is to be appreciated that although a patch jack is shown and described, this is an exemplary embodiment that can include electrical contact pair 100. Many other jacks known or developed in the future can also include electrical contact pair 100, as would be apparent to one of ordinary skill in the art upon reading and understanding the instant invention. For examples, jacks can have only one first conductor 202 or multiple pairs of first conductor 202. Therefore, a number of second conductors 204 will be dictated by an application including electrical contact pair 100. All other known and future developed jacks are contemplated within the scope of the present invention.

### Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. An electrical contact pair comprising:
a substantially cylindrical first conductor; and
an elongated second conductor having an end normally biased against said first conductor based on a spring-type resiliency of said second conductor, said end including a substantially V-shaped notch for engaging said first conductor.

2. The electrical contact pair of claim 1, wherein said second conductor comprises one of a rectangular, square, and circular cross-sectional shape.

3. The electrical contact pair of claim 1, wherein said V-shaped notch in said end increases Hertzian stress between said first and second conductors.

4. The electrical contact pair of claim 1, wherein at least a portion of the V-shaped notch is wider than a diameter of the first conductor.

5. An electrical contact pair comprising:
a substantially cylindrical first conductor; and
an elongated second conductor having an end normally biased against said first conductor based on a spring-type resiliency of said second conductor, said end being bifurcated to engage said first conductor via at least two contact points.

6. The electrical contact pair of claim 5, wherein said bifurcated end has a substantially V-shaped notch for engaging said first conductor.

7. The electrical contact pair of claim 6, wherein at least a portion of said V-shaped notch is wider than a diameter of said first conductor.

8. The electrical contact pair of claim 5, wherein said second conductor comprises one of a rectangular, square, and circular cross-sectional shape.

9. The electrical contact pair of claim 5, wherein said bifurcated end increases Hertzian stress between said first and second conductors.

10. A feed-through jack, comprising:
a body having a first end and a second end;
a substantially cylindrical conductor extending longitudinally through said body between a first jack at said first end and a second jack at said second end; and
an actuator assembly having a bifurcated contact configured to contact said substantially cylindrical conductor, said bifurcated contact being movable between a first position in electrical communication with said substantially cylindrical conductor and a second position electrically isolated from said substantially cylindrical conductor, wherein a plug inserted into said first jack causes said bifurcated contact to move to said second position.

11. The feed-through jack of claim 10, wherein bifurcated contact comprises a substantially V-shaped notch.

12. The feed-through jack of claim 11, wherein at least a portion of said V-shaped notch is wider than a diameter of said substantially cylindrical conductor.

13. The feed-through jack of claim 10, wherein said actuator comprises one of a rectangular, square, and circular cross-sectional shape.

14. The feed-through jack of claim 10, wherein said bifurcated contact increases Hertzian stress between said substantially cylindrical conductor and said bifurcated contact.

15. The feed-through jack of claim 10, further comprising:
a second substantially cylindrical conductor extending longitudinally through said body between a third jack at said first end and a fourth jack at said second end,
wherein said actuator assembly has a second bifurcated contact end configured to contact said second substantially cylindrical conductor, said second bifurcated contact end being movable between a first position in electrical communication with said substantially cylindrical conductor and a second position electrically isolated from said substantially cylindrical conductor, wherein a plug inserted into said third jack causes said second bifurcated contact end to move to said second position.

16. The feed-through jack of claim 10, wherein said actuator assembly further comprises:
a second bifurcated contact; and
a coupling device configured to hold said actuator assembly in a fixed position in said body.

17. The feed-through jack of claim 10, wherein said actuator assembly further comprises:
a non-conducting actuator coupled to said bifurcated contact.

18. The feed-through jack of claim 10, wherein said first jack is configured as one of a Western electric company (WECO) and a mini-WECO jack format.

19. The feed-through jack of claim 10, wherein said bifurcated contact is coupled through a termination resistor to ground in said second position.

20. A patch jack, comprising:
a body having a first end and a second end;
a first conductor extending longitudinally through said body between a first jack at said first end and a second jack at said second end;
a second conductor extending longitudinally through said body between a third jack at said first end and a fourth jack at said second end; and
a wishbone-shaped actuator assembly having first and second arms, each arm having a bifurcated contact configured to contact a substantially cylindrical portion of a respective one of said conductors, each of said arms having a first position in electrical communication with said respective conductor and being movable to a second position electrically isolated from said respective conductor, wherein a plug inserted into said first jack causes said first arm to move to said second position, and wherein a plug inserted into said third jack causes said second arm to move to said second position.

21. The patch jack of claim 20, wherein each of said bifurcated contacts comprise a substantially V-shaped notch.

22. The patch jack of claim 21, wherein at least a portion of each of said V-shaped notches is wider than a diameter of said substantially cylindrical portion of said first and second conductors.

23. The patch jack of claim 20, wherein said arms comprise one of a rectangular, square, and circular cross-sectional shape.

24. The patch jack of claim 20, wherein said bifurcated contacts increase Hertzian stress between said first and second conductors and said bifurcated contacts.

25. The patch jack of claim 20, wherein each of said arms further comprise:
a non-conducting actuator positioned on said arm to interact with said plug to cause said bifurcated contact to move to said second position.

26. The patch jack of claim 20, wherein said first jack and said third jack are configured as one of a Western electric company (WECO) and a mini-WECO jack format.

27. The patch jack of claim 20, wherein each of said arms of said actuator assembly is coupled through a termination resistor to ground in said second position.
